(19) United States
(12) Patent Application Publication
(10) Pub. No.: US 2010/0242056 A1
(43) Pub. Date: Sep. 23, 2010

(54) SLOT-IN DISK DRIVE WITH JAM-PROOF DEVICE

(76) Inventors: Yao-Ching Tsai, Taoyuan County (TW); Jen-Chen Wu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/626,952

(22) Filed: Nov. 30, 2009

(30) Foreign Application Priority Data
Mar. 17, 2009 (TW) 098108705

(51) Int. Cl. G11B 33/02

(52) U.S. Cl. 720/647; G9B/33.002

(57) ABSTRACT

The slot-in disk drive with a jam-proof device includes an upper housing, at least one guiding bar disposed under the upper housing, an end of the guiding bar pivoted to an inner wall of the slot-in disk drive, and a reception end of the guiding bar for guiding and driving an optical disk to slide in/out the slot-in disk drive, and a block disposed on the reception end. The elastic component of the jam-proof device includes a fixing portion fixed on the positioning slot of the reception end and an obstructing portion disposed between the block and the upper housing. The wear-resisting component is disposed on the upper surface of the obstructing portion of the elastic component for contacting the upper housing.

### BACKGROUND OF THE INVENTION

1. Field of the Invention

The present invention relates to a slot-in disk drive, and more particularly, to a slot-in disk drive with a jam-proof device for preventing an optical disk from jamming between a guiding bar and an upper housing.

2. Description of the Prior Art

A slot-in disk drive utilizes a plurality of guiding bars to guide and to drive an optical disk to move in/out the slot-in disk drive. Due to a gap between an end of the guiding bar and an upper housing of the slot-in disk drive, the optical disk is damaged easily when the optical disk is jammed into the gap in operation of the slot-in disk drive.

Please refer to FIG. 1. FIG. 1 is a sectional view of an optical disk device disclosed in TW publication no. 200534239. In order to prevent the optical disk from being damaged, the optical disk device includes a jam-proof device 10 disposed on an unloading bar 11. A cone base 12 is fixed on a reception end of the unloading bar 11. A recession 13 is formed on a center of the base 12. A constraining bolt 15 is disposed inside the recession 13 for constraining a movement of a block 16. A spring 17 is disposed inside the recession 13 and is sheathed on the constraining bolt 15. The spring 17 is further disposed under the block 16 for pushing the block 16 upward. The block 16 is moved upward to contact an upper housing 18 by an elastic force of the spring 17 so as to eliminate a gap between the unloading bar 11 and the upper housing 18. An optical disk 19 is guided to contact the block 16 on the unloading bar 11 by the cone base 12. Therefore, the optical disk 19 is not jammed into the gap when the optical disk 19 is guided to move in/out the optical disk drive by the block 16, so as to prevent the optical disk 19 from being damaged.

However, in order to utilize the block 16 to eliminate the gap, the conventional jam-proof device 10 includes the block 16 whereinside a hollow space is formed, so that the constraining blot 15 can be inserted into the hollow space of the block 16. Then, the block 16 can be moved upward and downward so as to follow a height variation of the upper housing 18 by the spring 17. Besides, the conventional jam-proof device 10 further includes the cone base 12 for guiding the optical disk 19 away from the spring 17. Therefore, the conventional jam-proof device 10 includes too many components and has a complicated structure. In addition, the upper housing 18 is worn easily when the block 16 contacts the upper housing 18, so that the optical disk 19 is moved in/out the optical disk device unevenly and is damaged easily. Furthermore, the conventional jam-proof device 10 is difficult to be assembled on the small reception end of the unloading bar 11. Thus, the conventional jam-proof device in the optical disk drive still has some problems which have to be solved.

### SUMMARY OF THE INVENTION

An objective of the present invention is to provide a slot-in disk drive with a jam-proof device for solving above drawbacks.

Another objective of the present invention is to provide the slot-in disk drive with the jam-proof device including an elastic component disposed on a reception end of a guiding bar for contacting an upper housing for blocking a gap, so as to simplify structure of the slot-in disk drive and to decrease manufacturing cost of the jam-proof device.

Another objective of the present invention is to provide the slot-in disk drive with the jam-proof device including a wear-resisting component disposed on an upper surface of an obstructing portion of the elastic component and contacting the upper housing so as to prevent the upper housing from being worn for keeping smooth operation of the slot-in disk drive.

Another objective of the present invention is to provide the slot-in disk drive with the jam-proof device including the elastic component integrated with the guiding bar monolithically so as to simplify the structure of the slot-in disk drive.

In order to achieve the foregoing objectives of the invention, the slot-in disk drive includes an upper housing, at least one guiding bar disposed under the upper housing, an end of the guiding bar being pivoted to an inner wall of the slot-in disk drive, and a reception end of the guiding bar guiding and driving an optical disk to slide in/out the slot-in disk drive, a block disposed on the reception end, and a jam-proof device. The jam-proof device includes an elastic component for contacting the upper housing so as to prevent the optical disk from jamming between the block and the upper housing. The elastic component includes a fixing portion fixed on the reception end, and an obstructing portion disposed between the block and the upper housing. The wear-resisting component is disposed on the upper surface of the obstructing portion of the elastic component for contacting the upper housing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a sectional view of an optical disk device in the prior art.

FIG. 2 is a diagram of a slot-in disk drive according to a preferred embodiment of the present invention.

FIG. 3 is an enlarged diagram of a section A shown in FIG. 2 according to the preferred embodiment of the present invention.

FIG. 4 is a sectional view of a jam-proof device along the line B-B shown in FIG. 3 according to the preferred embodiment of the present invention.

FIG. 5 is a diagram of the jam-proof device according to the preferred embodiment of the present invention.

FIG. 6 is a diagram of a jam-proof device according to another embodiment of the present invention.

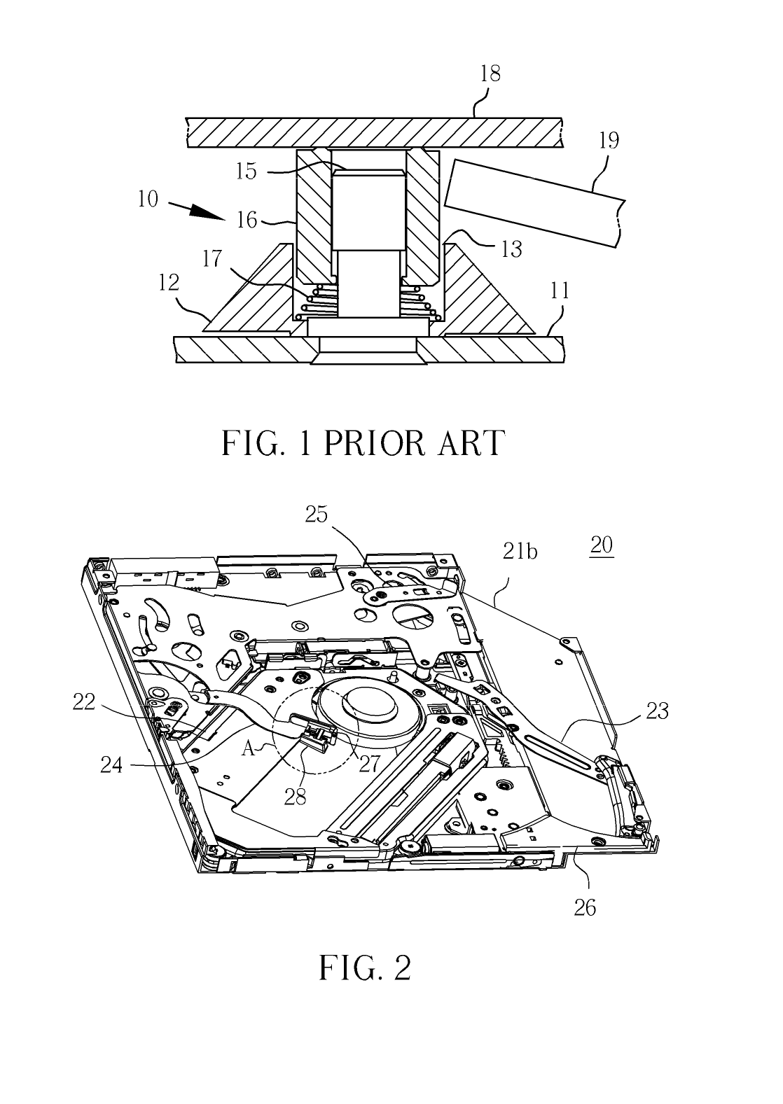

### DETAILED DESCRIPTION

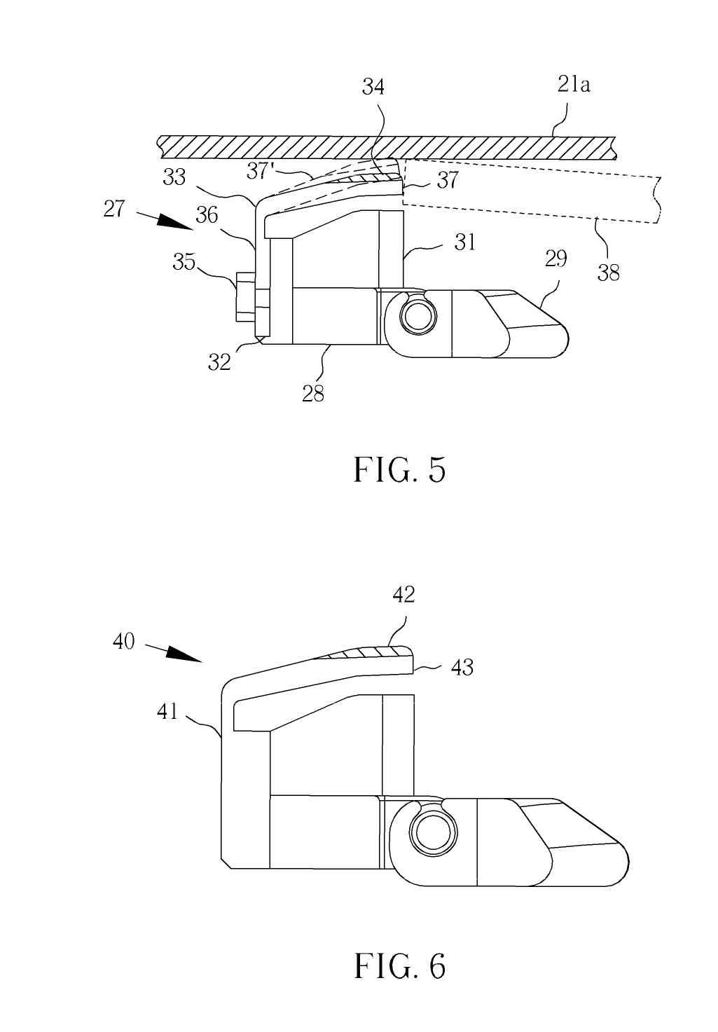

Please refer to FIG. 2. FIG. 2 is a diagram of a slot-in disk drive 20 according to a preferred embodiment of the present invention. The slot-in disk drive 20 includes an upper housing 21a shown in FIG. 5 and a lower housing 21b. A hollow space is formed inside the slot-in disk drive 20 and between the upper housing 21a and the lower housing 21b. The slot-in disk drive 20 further includes a traverse 22 and a plurality of guiding bars, such as a loading bar 23, an unloading bar 24, and a receiving bar 25. One end of each guiding bar is pivoted to an inner surface of the slot-in disk drive 20, and the other end of the guiding bar contacts an edge of an optical disk 38 so as to guide the optical disk 38 to move in/out through an opening 26 on a front end of the slot-in disk drive 20. In order to prevent the optical disk 38 from being jammed between the guiding bar and the upper housing 21a, a jam-proof device 27 is disposed on a reception end 28 of the unloading bar 24. Position of the jam-proof device 27 is not limited to the above-mentioned embodiment and depends on design demand.

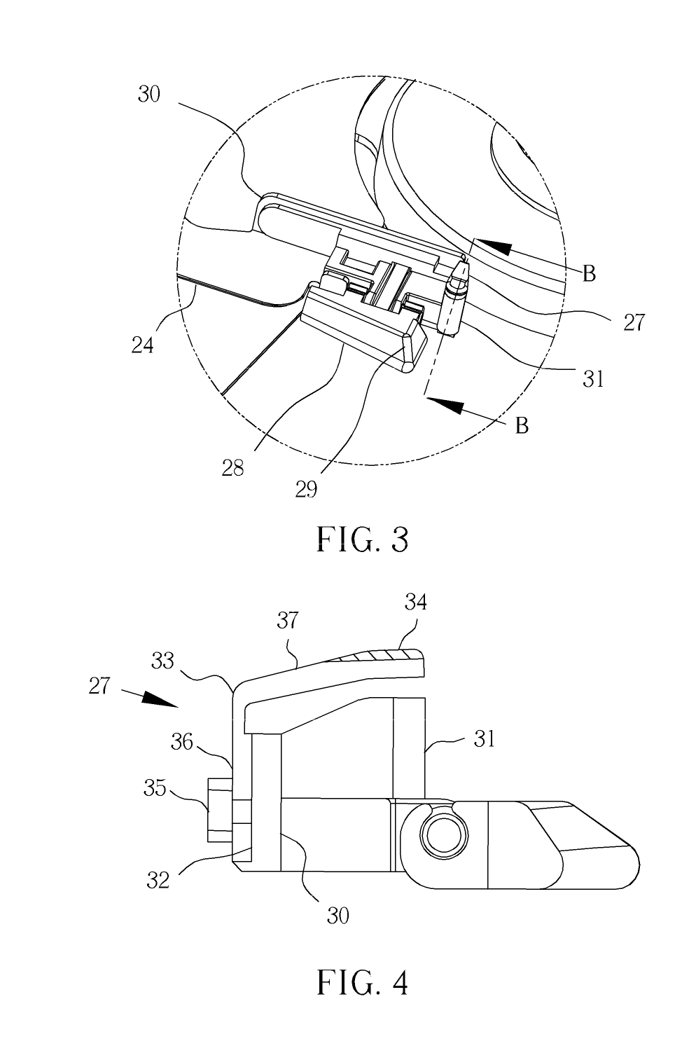

Please refer to FIG. 3. FIG. 3 is an enlarged diagram of a section A shown in FIG. 2 according to the preferred embodiment of the present invention. A structure of the reception end 28 of the unloading bar 24 is enlarged in FIG. 3. A guiding inclined surface 29 is formed on a side of the reception end 28 adjacent to a front end of the slot-in disk drive 20. A wall 30 in the form of double layers is disposed on the other side of the reception end 28 adjacent to a rear end of the slot-in disk drive 20. The wall 30 is stretched out to an edge of the reception end 28 so as to connect to a circular block 31. The block 31 is disposed under the jam-proof device 27.

Please refer to FIG. 4. FIG. 4 is a sectional view of the jam-proof device 27 along the line B-B shown in FIG. 3 according to the preferred embodiment of the present invention. A recession 32 is formed on a back of the wall 30 adjacent to the rear end of the slot-in disk drive 20 for fixing the jam-proof device 27. The jam-proof device 27 includes an elastic component 33, a wear-resisting component 34, and a screw 35. The elastic component 33 is similar to an L-shaped structure. The elastic component 33 includes a fixing portion 36 and an obstructing portion 37. The fixing portion 36 is fixed inside the recession 32 by the screw 35 for holding the obstructing portion 37 to be suspended above the block 31 and to be parallel with the block 31 substantially. Mechanism of fixing the fixing portion 36 inside the recession 32 is not limited to the above-mentioned embodiment and depends on actual demand. For example, the fixing portion 35 can be fixed inside the recession 32 by welding or riveting. The wear-resisting component 34 is disposed on an upper surface of the obstructing portion 37. The wear-resisting component 34 can be made of plastic material, rubber material, or urethane resin material. The wear-resisting component 34 can be fixed on the upper surface of the obstructing portion 37 by gluing, coating, or injecting.

Please refer to FIG. 5. FIG. 5 is a diagram of the jam-proof device 27 according to the preferred embodiment of the present invention. When the reception end 28 is installed on the end of the unloading bar 24, the fixing portion 36 of the elastic component 33 is fixed inside the recession 32 by the screw 35 for holding the obstructing portion 37 to move upward and downward with the wear-resisting component 34, as a dotted line 37′shown in FIG. 5, so as to contact the upper housing 21a when the reception end 28 is moved and to reduce a gap between the upper housing 21a and the block 31. When the optical disk 38 is moved toward the reception end 28, the edge of the optical disk 38 is guided to contact the block 31 by the guiding inclined surface 29. Then, the edge of the optical disk 38 is guided or driven by the block 31. When the optical disk 38 is slid away from the block 31 and enters the gap between the upper housing 21a and the block 31, the obstructing portion 37 of the elastic component 33 disposed inside the gap prevents the optical disk 38 from being jammed into the gap, and the obstructing portion 37 disposed on the reception end 28 can further guide the optical disk 38 to move in/out the opening 26.

Please refer to FIG. 6. FIG. 6 is a diagram of a jam-proof device 40 according to another embodiment of the present invention. In this embodiment, a structure of the jam-proof device 40 is similar to the structure of the jam-proof device 20. The jam-proof device 40 includes an elastic component 41 disposed on a reception end 43 and a wear-resisting component 42 disposed on the reception end 43. Difference between the jam-proof device 20 and the jam-proof device 40 is that the elastic component 41 is integrated with the reception end 43 monolithically, so that the jam-proof device 40 has a simplified structure and lower manufacturing cost.

Comparing to the prior art, the slot-in disk drive with the jam-proof device of the present invention can fix the elastic component on the reception end of the unloading bar by the screw easily, so that the elastic component can contact the upper housing to reduce the gap between the unloading bar and the upper housing for simplifying the structure and decreasing manufacturing cost. In addition, the jam-proof device of the present invention disposes the wear-resisting component on the upper surface of the elastic component, so that the wear-resisting component made of soft material can prevent the upper housing from being worn and keep smooth operation of the optical disk when the wear-resisting component contacts the upper housing of the slot-in disk drive.

Those skilled in the art will readily observe that numerous modifications and alterations of the device and method may be made while retaining the teachings of the invention.

What is claimed is:

1. A slot-in disk drive comprising:
an upper housing;
at least one guiding bar disposed under the upper housing, an end of the guiding bar being pivoted to an inner wall of the slot-in disk drive, and a reception end of the guiding bar guiding and driving an optical disk to slide in/out the slot-in disk drive;
a block disposed on the reception end; and
a jam-proof device comprising:
an elastic component comprising a fixing portion fixed on the reception end, and an obstructing portion disposed between the block and the upper housing and for contacting the upper housing so as to prevent the optical disk from jamming between the block and the upper housing.

2. The slot-in disk drive of claim 1, wherein a wear-resisting component is disposed on an upper surface of the obstructing portion for contacting the upper housing.

3. The slot-in disk drive of claim 2, wherein the wear-resisting component is made of plastic material, rubber material, or urethane resin material.

4. The slot-in disk drive of claim 2, wherein the wear-resisting component is disposed on the upper surface of the obstructing portion in an injection molding manner.

5. The slot-in disk drive of claim 1, wherein a guiding surface is formed on a side of the reception end adjacent to a front end of the slot-in disk drive.

6. The slot-in disk drive of claim 5, wherein a wall is formed on a side of the reception end adjacent to a rear end of the slot-in disk drive.

7. The slot-in disk drive of claim 6, wherein the wall is stretched out to an edge of the reception end so as to connect to the block.

8. The slot-in disk drive of claim 6, wherein a positioning slot is formed on the wall for fixing the fixing portion.

9. The slot-in disk drive of claim 8, wherein the fixing portion is screwed on the positioning slot.

10. The slot-in disk drive of claim 1, wherein the elastic component is integrated with the reception end monolithically.

11. The slot-in disk drive of claim 1, wherein the guiding bar is an unloading bar.
